(19) United States
(12) Patent Application Publication
(10) Pub. No.: US 2026/0129089 A1
(43) Pub. Date: May 7, 2026

(54) CROSS-CLOUD VIRTUAL PRIVATE ENDPOINT

(71) Applicant: International Business Machines Corporation, Armonk, NY (US)

(72) Inventors: David BREITGAND, HAIFA (IL); Dean Har'el Lorenz, Haifa (IL); Avi WEIT, Haifa (IL); Ofer BIRAN, HAIFA (IL); Katherine BARABASH, Haifa (IL)

(21) Appl. No.: 18/934,239

(22) Filed: Nov. 1, 2024

(51) Int. Cl. H04L 67/1008; H04L 47/2425; H04L 67/101

(52) U.S. Cl. CPC H04L 67/1008; H04L 47/2425; H04L 67/101

(57) ABSTRACT

In some implementations, a computing device may provide an indication of availability of a producer workload, located on a first virtual private cloud (VPC) or being a cloud application programming interface (API) on a first cloud, as a virtual private endpoint (VPE) to a consumer workload in a second VPC on a second cloud that is different from the first cloud. The computing device may receive, from the consumer workload and based at least in part on the indication of availability, a request for access to the producer workload. The computing device may establish, based at least in part on the request, the producer workload as the VPE in the second VPC via a link between the first cloud and the second cloud.

### BACKGROUND

Virtual private clouds (VPCs) may be used to run enterprise workloads in a cloud computing environment (“cloud”). A virtual private endpoint (VPE) is a private internet protocol (IP) address within a VPC that may be used to access a service outside of the VPC. For example, a VPE may be used to access cloud services or workloads in other VPCs without leaving a cloud vendor network. The access may be subject to a service level agreement (SLA) or other policies. Users of the VPC may use a VPE to avoid the public internet when communicating with services outside of the VPC.

### SUMMARY

In some implementations, a method comprises providing an indication of availability of a producer workload, located on a first virtual private cloud (VPC) or (the producer workload) being a cloud application programming interface (API) on a first cloud, as a virtual private endpoint (VPE) to a consumer workload in a second VPC on a second cloud that is different from the first cloud. The method further comprises receiving, from the consumer workload and based at least in part on the indication of availability, a request for access to the producer workload. The method further comprises establishing, based at least in part on the request, the producer workload as the VPE in the second VPC via a link between the first cloud and the second cloud.

In some implementations, a computer program product comprises: one or more computer readable storage media, and program instructions collectively stored on the one or more computer readable storage media. The computer program product includes instructions comprising program instructions to provide an indication of availability of a producer workload, located on a first VPC or being a cloud API on a first cloud, as a VPE to a consumer workload in a second VPC on a second cloud that is different from the first cloud; program instructions to receive from the consumer workload and based at least in part on the indication of availability, a request for access to the producer workload; program instructions to identify, based at least in part on the request, a service level objective (SLO) for a link between the producer workload and the consumer workload; and program instructions to establish, based at least in part on the SLO, the producer workload as the VPE in the second VPC via the link between the first cloud and the second cloud.

In some implementations, a system comprises one or more devices configured to provide an indication of availability of a producer workload, located on a first VPC or being a cloudAPI on a first cloud, as a VPE to a consumer workload in a second VPC on a second cloud that is different from the first cloud. The system further comprises one or more devices configured to receive, from the consumer workload and based at least in part on the indication of availability, a request for access to the producer workload. The system comprises one or more devices configured to establish, based at least in part on the request, the producer workload as the VPE in the second VPC via a link between the first cloud and the second cloud.

### BRIEF DESCRIPTION OF THE DRAWINGS

FIGS. 1A-1G are diagrams of an example implementation described herein.

FIG. 2 is a diagram of an example implementation described herein.

FIG. 3 is a diagram of an example computing environment in which systems and/or methods described herein may be implemented.

FIG. 4 is a diagram of example components of one or more devices of FIGS. 1 and 2.

FIG. 5 is a flowchart of an example process associated with a cross-cloud virtual private endpoint (VPE).

### DETAILED DESCRIPTION

The following detailed description of example implementations refers to the accompanying drawings. The same reference numbers in different drawings may identify the same or similar elements.

Virtual private endpoints (VPEs) may be used in a virtual computing environment to provide access inside of a virtual private cloud (VPC) or to a cloud application programming interface (API) to a workload that is not within the VPC but is within a same cloud as the VPC. For example, a cloud provider may provide multiple VPCs to different clients, with all of the multiple VPCs residing within an overarching cloud environment of the cloud provider (e.g., using a network of connected computing devices hosting virtual machines, among other examples).

When a consumer workload in a VPC on a cloud accesses a producer workload on a different cloud, the consumer workload may access the producer workload via a public connection such as the internet. In this way, the consumer workload and the producer workload may communicate inefficiently and fail to achieve link benefits that may be achieved when using a VPE within a cloud.

In some aspects described herein, a computing device may establish a link between clouds (e.g., different cloud environments associated with different cloud providers) to provide a VPE (e.g., a cross-cloud VPE) from a VPC on one cloud to another VPC on another cloud. The link between clouds (e.g., a peered connection) associated with the VPE may provide security, controlled routing (e.g., via internal cloud peering, enterprise private network, or optimized overlay over the public internet, among other options), improved operating costs, or service level agreement (SLA) support, among other examples, in contrast to a public connection. Additionally, or alternatively, the link may support non-standardized cloud configurations between the clouds and the cloud vendors are not required to collaborate on a common scheme.

In some aspects, a plurality of VPCs exist in a plurality of clouds. A producer VPC in a first cloud and one or more consumer VPCs exist in the second cloud and/or additional clouds. A control plane, configured to control a cross-cloud VPE, may be used to support providing a VPE associated with the producer workload to the one or more consumer VPCs having consumer workloads. In some aspects, the control plane may be associated with, or provided by, a computing device. The computing device may be associated with a server that is independent from the clouds or the computing device may be part of a cloud computing environment.

The producer workload (e.g., a controller or owner of the producer workload) may provide an indication (e.g., publish) that the producer workload is enabled for a cross-cloud VPE. One or more of the consumer workloads (e.g., controllers or owners of the one or more consumer workloads) may request cross-cloud access to the producer workload as a VPE associated with producer workload (e.g., advertised as enabled for cross-cloud VPE service).

In some aspects, the control plane associated with the cross-cloud VPE may create VPEs (e.g., cross-cloud VPEs or surrogates) in the consumer VPCs, where the cross-cloud VPEs appear as single cloud VPE (e.g., part of the respective cloud associated with a VPC). The control plane may create a domain name system (DNS) configuration in a consumer VPC that resolves a consumer service name into a cross-cloud VPE private local address. The control plane may create connectivity (e.g., a data plane) between VPCs in different clouds based at least in part on a required service level objective (SLO) of the connectivity and/or the control plane may create or identify a routing rules configuration to enable usage of the data plane supporting the cross-cloud VPE by cross-cloud traffic.

In some aspects, the control plane may (e.g., using an API) define and/or manage cross-cloud identity and access management (IAM) roles, identities, and policies associated with publishing or unpublishing workloads as services to which cross-cloud VPEs can be created. The control plane may publish and/or unpublish workloads to enable cross-cloud VPE creation subject to IAM roles and policies defined in the control plane. The control plane may create cross-cloud VPEs that appears like a local (e.g., within a same cloud) VPE in consumer VPCs having access to the producer workload. In some aspects, the VPCs may be associated with multiple clouds and/or may include multiple VPCs from the same cloud. In some aspects, the control plane may configure, observe, manage, and/or modify (e.g., to improve efficiencies) a custom cross-cloud VPC data plane. The control plane may configure network address translation (NAT), routing, and/or DNS to enable communication between the consumer workload and the producer workload. In some aspects, the control plane may include an identity manager, a policies database, a cross-cloud VPE manager, a cross-cloud VPE configuration, cross-cloud VPE observation (e.g., to monitor performance), and cross-cloud VPE optimization components (e.g., to modify the link between clouds to improve performance), among other examples.

In some aspects, the control plane may establish a producer surrogate on consumer VPCs and consumer surrogates on the producer VPC, implemented as single-cloud VPEs-enabled services running in respective VPCs. In some aspects, the control plane may configure a data plane for a custom cross-cloud VPC link that interconnects consumer surrogates with the producer surrogate, with the link being subject to privacy, performance, and cost control service level objectives (SLOs).

In some aspects, the control plane may be located on an API server or other computing device. In some aspects, a computing device associated with the control plane may include or have access to storage and/or an SLA repository. The storage may include information associated with policies, secondary accounts, IAM roles, security groups, and/or organizations. The SLA repository may store a set of selectable SLAs for cross-cloud VPEs. The control plane may receive an indication of a selected SLA, a request to publish a producer service (e.g., associated with a producer workload), and/or a request for a cross-cloud VPE (e.g., based at least in part on providing an indication to VPCs that the producer workload is available) among other examples. The control plane may select parameters associated with the a selected SLA and validate policies and/or roles via information of the storage. The control plane may create a consumer surrogate (e.g., a VPE associated with the consumer workload on the producer workload VPC) and a producer surrogate (e.g., a VPE associated with the producer workload on the consumer workload VPC).

In some aspects, the link between clouds may include the internet (e.g., a link overlaid on the internet), a virtual private network (VPN), or an enterprise network having access networks associated with each of the clouds, among other examples. For example, a custom cross-cloud data plane may be implemented using a VPN or a service. In some aspects, the producer surrogate in the first cloud is connected to an on-prem network using a hybrid cloud connectivity of a vendor of the first cloud and the consumer surrogate is connected to an on-prem network using hybrid cloud connectivity of the second cloud vendor and either a multiprotocol label switching (MPLS) connection or the private network of the enterprise may be used to interconnect the consumer surrogate and the producer surrogate to avoid public internet or a collocation facility.

In some aspects, the link may use a collocation facility to perform traffic handover between the clouds. For example, the collocation facility may translate communications from the producer workload cloud for use in the consumer workload cloud, and/or may translate comms from the consumer workload cloud for use in the producer workload cloud.

In some aspects, the control plane may be a managed service (e.g., managed by one or more cloud providers or by a device associated with the producer workload), a self-hosted service, or a command line interface (CLI) executing locally on a computing device with meta information, stored in local storage, associated with the link and cross-cloud VPEs in local storage or a database of an associated computing device (e.g., of an administrator).

In some aspects, the control plane may define a desired state of communications for each consumer workload and producer workload pair. In some aspects, the control plane may store or have access to SLOs on communications between the consumer workload and the producer workload.

The control plane may include, or be associated with, an observability engine configured to observe a state of the link (e.g., private communication link) between the consumer workload and the producer workload associated with the cross-cloud VPE. The control plane or an associated operator may modify a configuration and/or parameters of the link to reconcile an observed state and desired state for communications between the consumer workload and the producer workload. In some aspects, the control plane or the associated operator may periodically, aperiodically, or continually observe the state of the link to determine whether to modify the configuration and/or parameters of the link. In some aspects, the control plane may perform the observation and modification via a cluster management system, such as a Kubernetes (K8s) or openshift container platform (OCP) operator. An operator may include a specific design pattern, in which there is a component called “controller” that attempts to continuously reconcile an observed state of a managed system with the desired state.

In an example using a Python operation, a set of operations to use cross-cloud VPEs may include pip install cross-cloud-vpe [c1, c2, c3] to creates a virtual environment on an admin computer (e.g., laptop) for clouds c1, c2, c3 by installing clouds' CLIs and SDK for these clouds. Another operation may include cross-cloud-vpe check [c] to report a status of a virtual environment for cloud c on the admin laptop. Another operation may include cross-cloud-vpe create/revoke/extend id [c1, c2, c3] to creates/revoke/extend a global ID known to a cross-cloud VPE control plane (e.g., as a “passport”). The global ID may be connected to locally known c1, c2, c3 IDs (e.g., as “visas”).

Another operation may include cross-cloud-vpe publish <service name> [id trust list] [reuse [id trust list]] to enable cross-cloud VPE creation for a global ID trust list. There may be an optional reuse policy for the global ID trust list. If trust lists are not specified, then by default only the same global ID that publishes the service may be allowed to a create cross-cloud VPE. In some aspects, the control plane may create a consumer surrogate in the service provider cloud.

Another operation may include cross-cloud-vpe create <service name> <global consumer ID> [reuse] [SLOs] to creates a producer surrogate on the producer cloud side. In some aspects, the control plane may reuse an already existing producer surrogate. In some aspects, the control plane may establish a data path between the producer and consumer surrogates subject to SLOs on privacy, cost, or performance, among other examples. The cross-cloud VPE may become available in the consumer VPC and DNS, NAT, and routing may be configured.

In some aspects, the control plane may (e.g., based at least in part on performance or lack of use) perform an operation of Cross-cloud-vpe delete <global consumer ID> <service name > to remove a producer workload from the list of available producer workloads for cross-cloud VPE.

Based at least in part on supporting cross-cloud VPEs, VPCs on different clouds may communicate with IAM roles and policies in place that may not otherwise be available if using a public link outside of a single cloud. For example, cross-cloud VPEs support SLA and SLO management for the link.

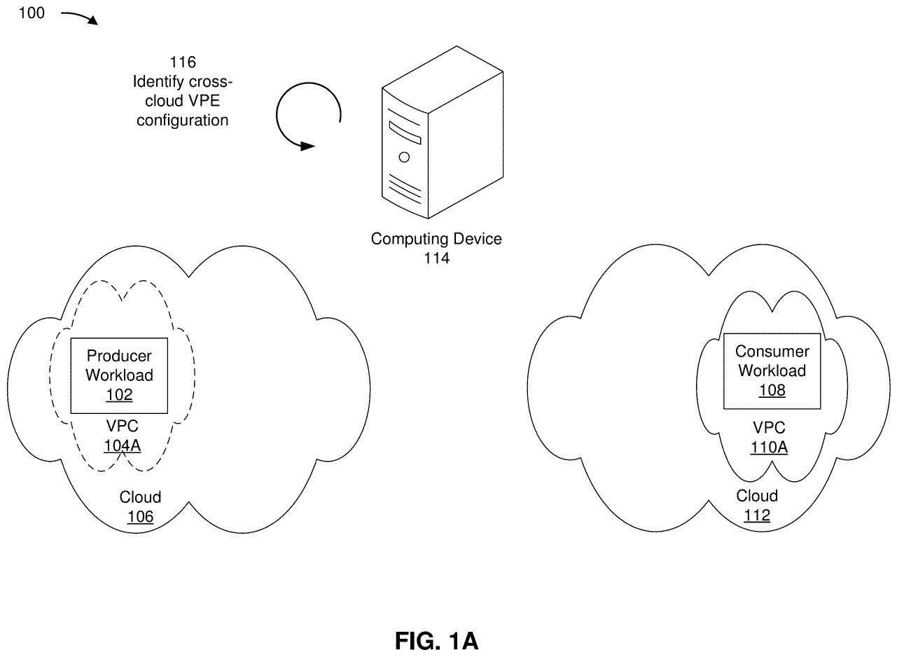

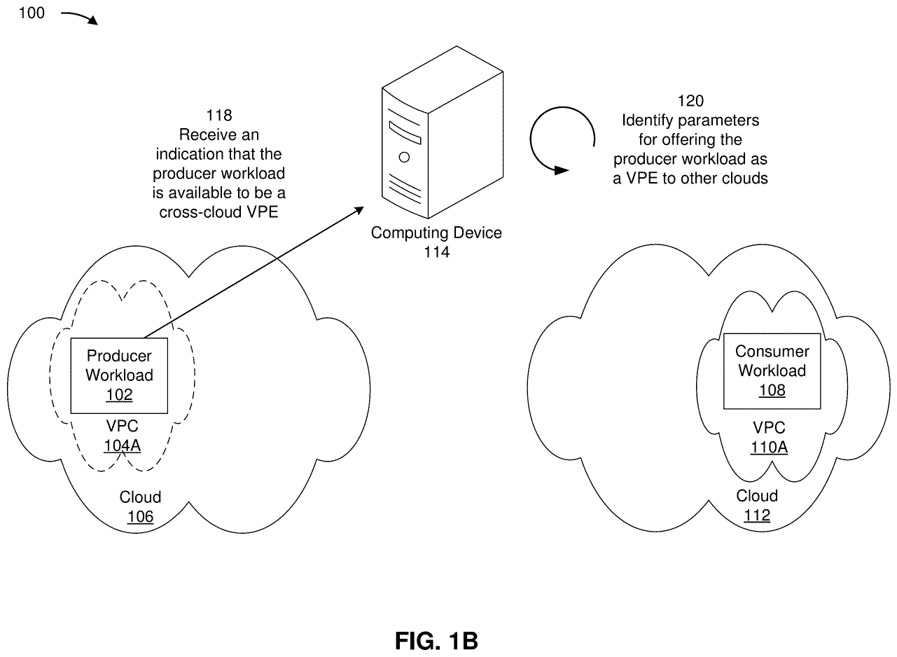

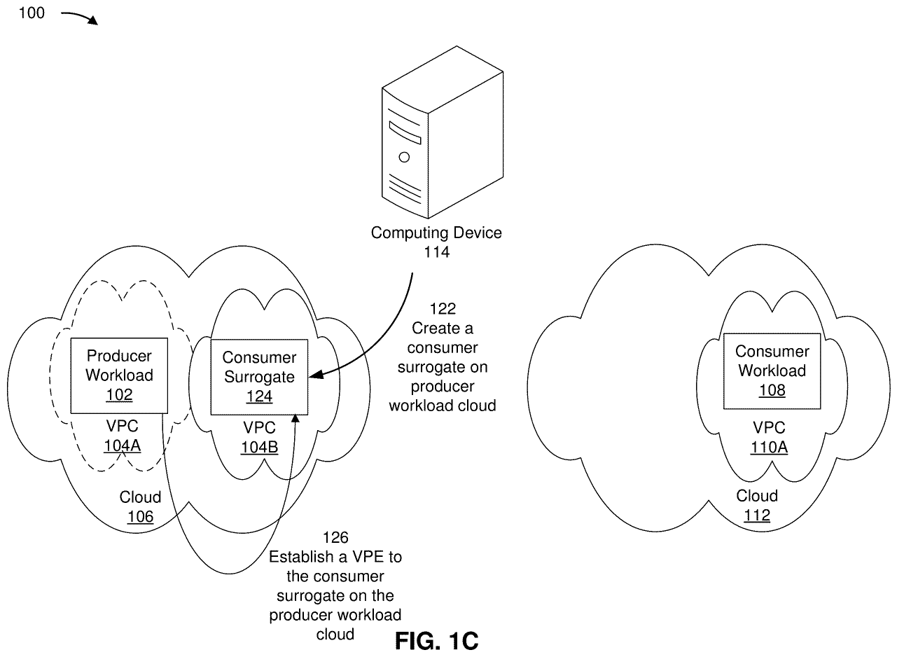

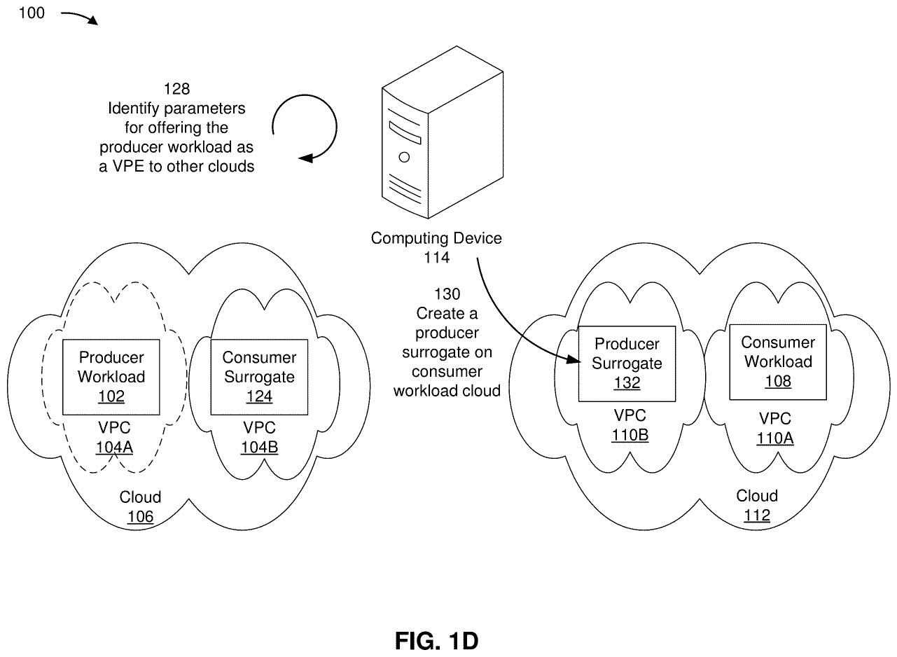

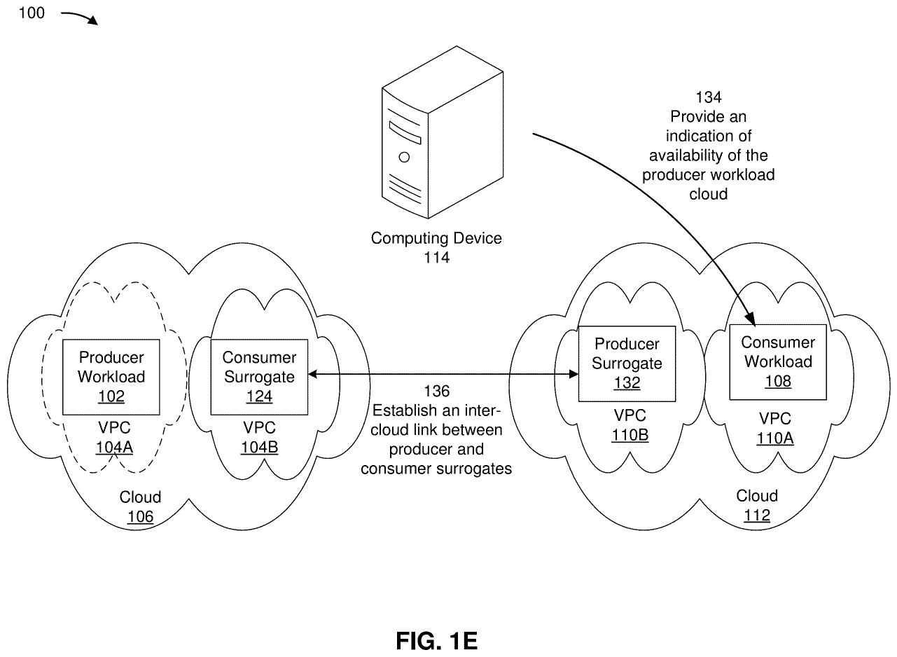

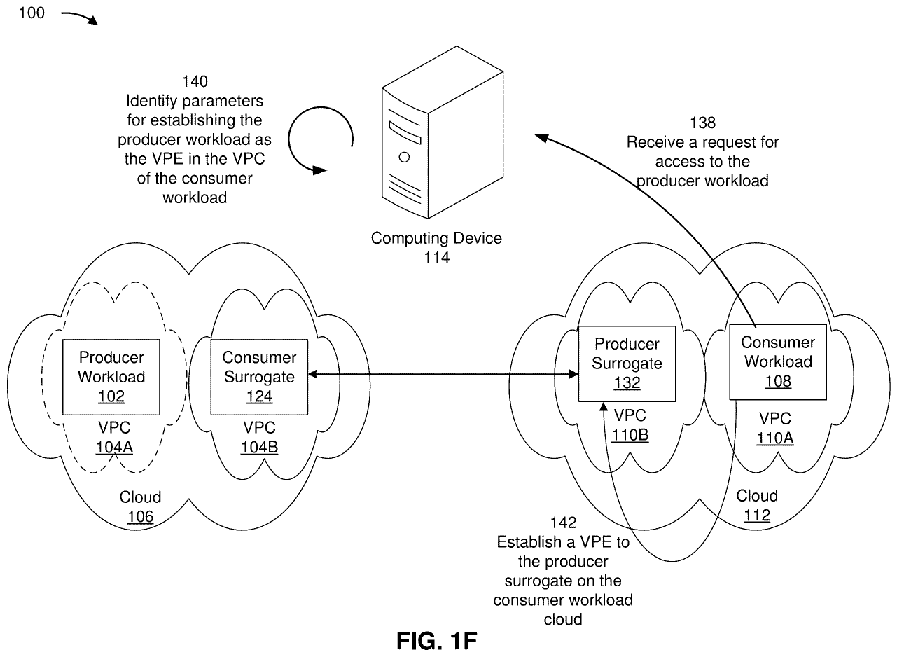

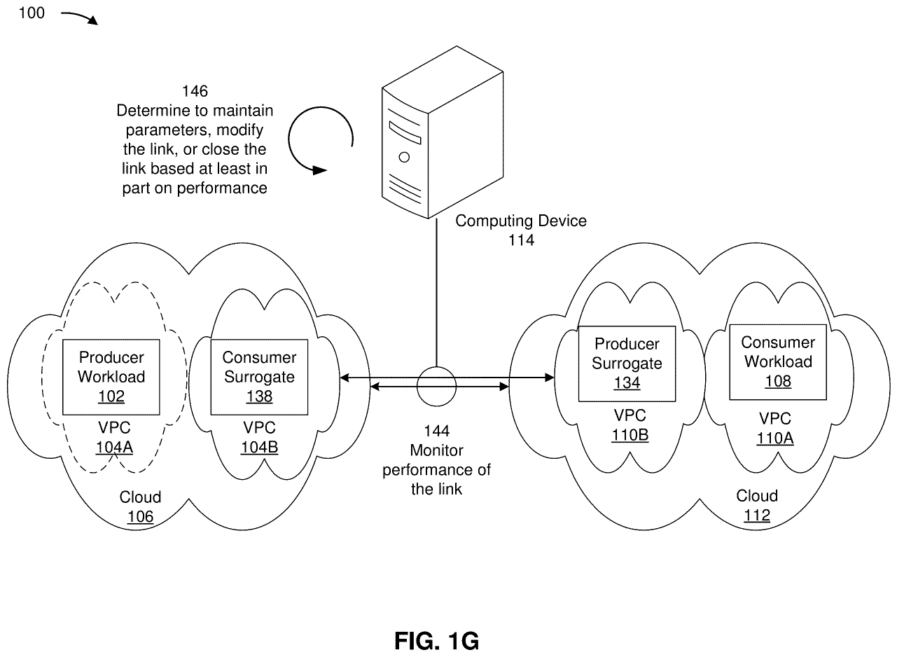

FIGS. 1A-1G are diagrams of an example implementation 100 described herein. As shown in FIGS. 1A-1G, example implementation 100 includes a producer workload 102 that may be on a VPC 104A or may be associated with a cloud API (e.g., no VPC 104A) that is on a cloud 106. In other words, the VPC 104A is shown as an optional implementation where the producer workload 102 is on a VPC, and in other implementations, the producer workload 102 is not on a VPC of the cloud 106. The example implementation 100 further includes a consumer workload 108 on a VPC 110A that is on a cloud 112.

As shown in FIG. 1A, and by reference number 116, a computing device 114 may identify a cross-cloud VPE configuration for supporting an intercloud communication link between the producer workload 102 and the consumer workload 108. In some aspects, the computing device 114 may include a control plane configured to support cross-cloud VPEs for communications between the producer workload 102 and the consumer workload 108 on different clouds. In some aspects, the computing device 114 may include a virtual machine associated with the producer workload 102, an application programming interface (API) server, or a collocation facility, among other examples.

In some aspects, the computing device 114 may include an identity manager, a policies database, a cross-cloud VPE manager, a cross-cloud VPE configuration database and/or manager, a cross-cloud VPE observation module or component, and/or a cross-cloud VPE optimization manager or component, among other examples. The computing device 114 may be configured to support configuration, observation, management, and/or optimization of cross-cloud VPC data planes (e.g., custom or per-link cross-cloud VCP data planes).

FIGS. 1B-1C depict a process of making the producer workload available to a cross-cloud VPE. The availability includes creating a consumer surrogate in a distinct VPC in the producer workload cloud 106 and connecting the consumer surrogate to the producer workload via a VPE. The producer might be any valid target for VPE: either a service inside a VPC or being a cloud API. At the time of making the producer workload available to cross-cloud VPE, the management plane might indicate SLOs under which the producer workload will be available.

As shown in FIG. 1B, and by reference number 118, the computing device 114 may receive an indication that the producer workload 102 is available to be a cross-cloud VPE. In some aspects, the computing device 114 may receive the indication via a connection with the cloud 106 or via a public network (e.g., the internet). The computing device 114 may save the indication within storage associated with a set of available producer workloads for cross-cloud VPEs.

As shown by reference number 120, the computing device 114 may identify parameters for offering the producer workload 102 as a VPE to other clouds. For example, the computing device 114 may identify security parameters, routing parameters (e.g., internal cloud peering, enterprise private network, or optimized overlay over the public internet, among other examples), cost parameters (e.g., computing resources used, cost of using other devices, among other examples), and/or performance parameters (e.g., an SLA and/or SLO, among other examples), among other examples.

As shown in FIG. 1C, and by reference number 122, the computing device 114 may create a consumer surrogate 124 on the producer workload cloud 106. In some aspects, the VPE of the consumer workload 108 may be established as the consumer surrogate 124 within the VPC 104B. In this way, the producer workload 102 may communicate with the consumer workload 108, with the consumer surrogate 124 appearing as a single-cloud VPE in the VPC 104B. The consumer surrogate 124 and the consumer workload 108 may communicate via a link between clouds 106 and 112 (e.g., via internal cloud peering, an enterprise private network, a tunnelling network, and/or an optimized overlay over the public internet, among other examples).

As shown by reference number 126, the computing device 114 or another device may establish a VPE to the consumer surrogate 124 on the producer workload cloud 106. For example, the VPE to the consumer surrogate 124 may establish a communication channel between the producer workload 102 and the consumer surrogate 124. In some aspects, the computing device may establish the consumer workload 108 as a VPE in a VPC 104B on the cloud 106 that includes the producer workload 102. In some aspects, the VPE of the consumer workload 108 may be established as a consumer surrogate 124 within a VPC 104B. In this way, the producer workload 102 may communicate with the consumer workload 108, with the consumer surrogate 124 appearing as a single-cloud VPE in the VPC 104B. The consumer surrogate 124 and the consumer workload 108 may communicate via a link between clouds 106 and 112 (e.g., via internal cloud peering, an enterprise private network, a tunnelling network, and/or an optimized overlay over the public internet, among other examples).

FIGS. 1D-1E depict a process that includes the creation of a producer surrogate on the consumer cloud 112, connecting the producer surrogate to a consumer surrogate across clouds under parameters determined in connection with reference number 120, and providing a notification that the producer workload is now available on the consumer cloud 112. The producer surrogate serves as a “remote service attachment” to the producer workload 102 via the consumer surrogate.

As shown in FIG. 1D, and by reference number 128, the computing device 114 may determine whether to advertise the producer workload 102 and/or identify clouds or VPCs to offer the producer workload 102. In some aspects, the computing device 114 may determine whether to advertise the producer workload 102 based at least in part on SLAs or SLOs associated with the producer workload 102 and/or based at least in part on resources available to support a cross-cloud VPE associated with the producer workload 102. In some aspects, the SLOs and/or SLAs may be associated with one or more of a data rate of communications between the producer workload 102 and the consumer workload 108, a latency of the communications between the producer workload 102 and the consumer workload 108, a privacy configuration of the communications between the producer workload 102 and the consumer workload 108, or a cost of the communications between the producer workload 102 and the consumer workload 108.

In some aspects, the computing device 114 may identify clouds or VPCs to offer the producer workload 102 for cross-cloud VPE based at least in part on SLAs or SLOs associated with the VPCs and/or based at least in part on resources available to support a cross-cloud VPE associated with the producer workload 102 and the VPCs. In some aspects, the computing device 114 may identify cross-cloud IAM roles, identities, and policies associated with publishing or unpublishing workloads as services to which cross-cloud VPEs can be created.

As shown by reference number 130, the computing device 114 may create a producer surrogate 132 on consumer workload cloud 112. In some aspects, the producer surrogate 132 may be configured to forward traffic to the consumer surrogate 124 over an intercloud link. In some examples, the computing device 114 may establish the VPE of the producer workload 102 as the producer surrogate 132 within a VPC 110B. In this way, the consumer workload 108 may communicate with the producer workload 102 via the producer surrogate 132, with the producer surrogate 132 appearing as a single-cloud VPE in the VPC 110B on the cloud 112 that also has the VPC 110A. The producer surrogate 132 and the producer workload 102 may communicate via the link between clouds (e.g., via internal cloud peering, an enterprise private network, a tunnelling network, and/or an optimized overlay over the public internet, among other examples).

In some aspects, to establish the producer workload 102 as the VPE in the VPC 110B within the cloud 112 of the consumer workload 108, the computing device 114 may establish the link with a control plane and a data plane between the cloud 106 and the cloud 112, establish an SLO of the link, establish a domain name system in the VPC 110 that resolves a consumer service name of the producer workload 102 to a local address of the VPC 110B, and/or establish a routing configuration for the link, among other examples.

As shown in FIG. 1E, and by reference number 134, the computing device 114 may provide an indication of availability of the producer workload 102 (e.g., as a VPE on other clouds) to the consumer workload 108. In this way, the computing device 114 may publish the producer workload 102 to enable cross-cloud VPE creation. In some aspects, the computing device 114 may indicate one or more of the parameters (e.g., IAM roles and/or policies) that are associated with the producer workload 102 when used as a cross-cloud VPE. In some aspects, the computing device 114 may provide the indication to multiple consumer workloads on the VPC 110A, to multiple consumer workloads on multiple VPCs of the cloud 112, and/or to multiple VPCs on multiple clouds.

As shown by reference number 136, the computing device 114 may establish an inter-cloud link between the producer surrogate 124 and the consumer surrogate 124. In some aspects, the computing device 114 may establish an inter-cloud link between the clouds 106 and 112 and between the VPC 104A (in implementations where the producer workload 102 is on a VPC) and VPC 110B. In some aspects, the computing device 114 may establish a link between the producer workload 102 (e.g., as a cloud API on the cloud 106) and the producer surrogate 124 or the consumer workload 108. For example, the computing device 114 may establish the link based at least in part on an SLA, an SLO, or other parameters associated with the producer workload 102 or the consumer workload 108, among other examples.

FIG. 1F depicts how the consumer workload connects to the producer workload. When a request is received to connect via cross-cloud VPE from the consumer workload to the producer workload, a VPE is created in the consumer workload VPC to the producer surrogate, subject to previously advertised SLOs.

As shown in FIG. 1F, and by reference number 138, the computing device 114 may receive a request for access to the producer workload 102. In some aspects, the computing device 114 may receive the request via a request associated with the consumer workload 108, the VPC 110, and/or the cloud 112, among other examples.

As shown by reference number 140, the computing device 114 may identify parameters for establishing the producer workload 102 as the VPE in the VPC 110 of the consumer workload 108. For example, the computing device 114 may establish an SLA or SLO, a routing configuration (e.g., via internal cloud peering, enterprise private network, tunnelling, and/or an optimized overlay over the public internet, among other examples), security parameters, and/or cost optimization, among other examples. In some aspects, the SLO or SLA is based at least in part on the producer workload 102, the consumer workload 108, or a pairing of the producer workload 102 and the consumer workload 108. Additionally, or alternatively, the computing device 114 may define and/or manage IAM roles, identities, and/or addresses associated with the VPE of the producer workload 102 being used in the VPC 110A or 110B.

As shown by reference number 142, the computing device 114 may establish a VPE to the producer surrogate 132 on the consumer workload cloud 112. For example, the VPE to the producer surrogate 132 may establish a communication channel between the consumer workload 108 and the producer surrogate 132.

As shown in FIG. 1G, and by reference number 144, the computing device 114 may monitor performance of the link between clouds 106 and 112 and/or between any of the VPCs 104A, 104B, 110A, and 110B. For example, the computing device 114 may identify latency, throughput, error rates, or connection instabilities of the link, among other examples.

As shown by reference number 146, the computing device 114 may determine to maintain parameters, modify the link, or close the link based at least in part on performance of the link. For example, if the link satisfies the SLA and/or SLO or other parameters, the computing device 114 may determine to maintain current parameters. If the computing device 114 identifies an improved routing configuration (e.g., lower cost, improved performance, or more efficient), or if the computing device 114 determines that the SLA and/or SLO are not satisfied, among other examples, the computing device 114 may modify the parameters or close the link.

In some aspects, the computing device 114 may determine that the producer workload 102 is not available for cross-cloud VPE service based at least in part on the performance. The computing device 114 may unpublish the producer workload 102 as an available cross-cloud VPE and/or may provide an indication to consumer workloads or VPC already linked to the producer workload 102 that the link is to be closed.

As indicated above, FIGS. 1A-1G are provided as an example. Other examples may differ from what is described with regard to FIGS. 1A-1G. The number and arrangement of devices shown in FIGS. 1A-1G are provided as an example.

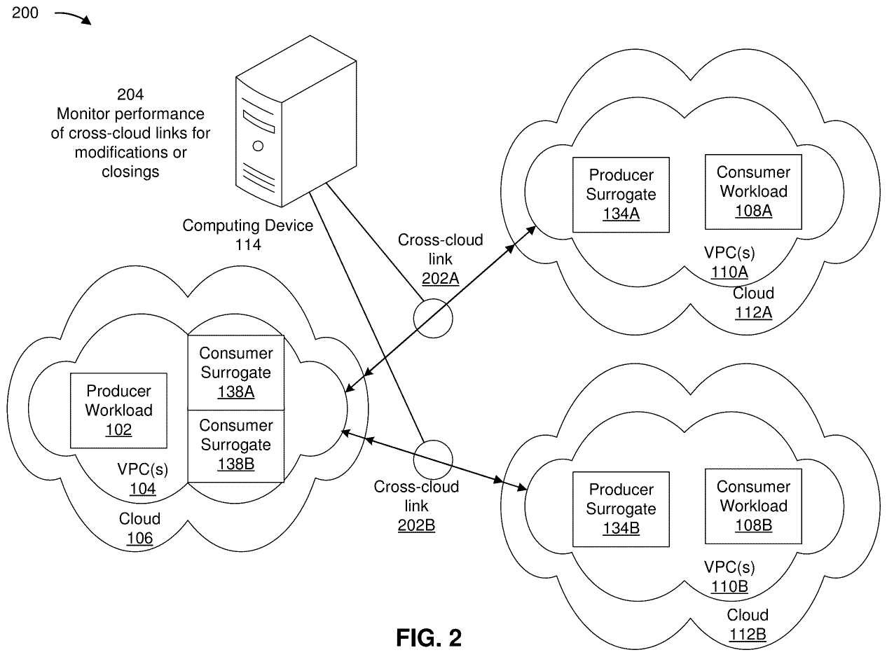

FIG. 2 is a diagram of an example implementation 200 described herein. As shown in FIG. 2, example implementation 200 includes the producer workload 102, a set of one or more VPCs 104 on the cloud 106, and the computing device 114 of FIGS. 1A-1G. Additionally, FIG. 2 shows multiple consumer workloads 108A and 108B, multiple sets of one or more VPCs 110A and 110B on respective clouds 112A and 112B. The set of one or more VPCs 110A includes a producer surrogate 134A to appear as a single cloud VPE to the consumer workload 108A. In some aspects, the producer surrogate 134A and the consumer workload 108A may be on different VPCs within the cloud 112A. The set of one or more VPCs 110B includes a producer surrogate 134B to appear as a single cloud VPE to the consumer workload 108B. In some aspects, the producer surrogate 134B and the consumer workload 108B may be on different VPCs within the cloud 112B. The set of one or more VPCs 104 includes a consumer surrogate 138A associated with consumer workload 108A and a consumer surrogate 138B associated with consumer workload 108B, with consumer surrogates 138A and 138B appearing as a single cloud VPE on the VPC 104. In some aspects, the consumer surrogate 138A and the producer workload 102 may be on different VPCs within the cloud 106. In some aspects, the consumer surrogate 138B and the producer workload 102 may be on different VPCs within the cloud 106. In some aspects, the consumer surrogate 138A and the consumer surrogate 138B may be on different VPCs within the cloud 106. In some aspects, the producer workload 102 may not be associated with a VPC and may be a cloud API within the cloud 106.

The computing device 114 has established cross-cloud link 202A between clouds 106 and 112A or between the set of one or more VPCs 104 and the set of one or more VPCs 110A to support communications between the surrogates and workloads across clouds. The computing device 114 has established cross-cloud link 202B between clouds 106 and 112B or between the set of one or more VPCs 104 and the set of one or more VPCs 110B to support communications between the surrogates and workloads across clouds.

As shown by reference number 204, the computing device 114 may monitor performance of cross-cloud links for modifications or closings. For example, the computing device 114 may identify only one of the cross-cloud link 202A or 202B for closing or modification of parameters based on performance of the respective cross-cloud links. Alternatively, the computing device 114 may determine to close all links and/or to unpublish producer workload 102 as an available service for a cross-cloud VPE based at least in part on performance of the respective cross-cloud links.

As indicated above, FIG. 2 is provided as an example. Other examples may differ from what is described with regard to FIG. 2. The number and arrangement of devices shown in FIG. 2 are provided as an example.

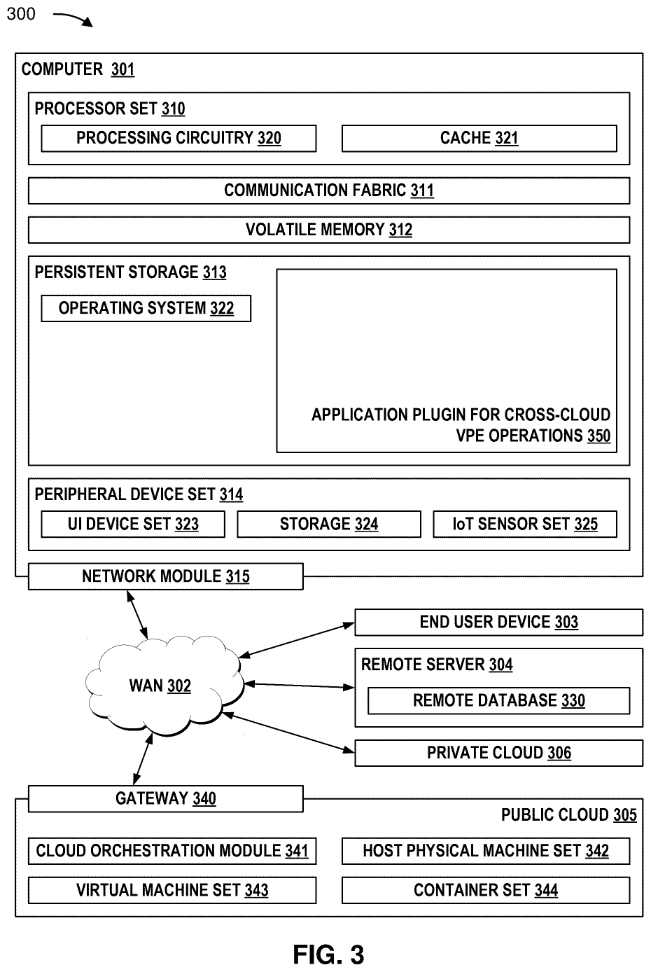

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as application plugin for cross-cloud VPE operations 350. In addition to application plugin for cross-cloud VPE operations 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and application plugin for cross-cloud VPE operations 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in application plugin for cross-cloud VPE operations 350 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in application plugin for cross-cloud VPE operations 350 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

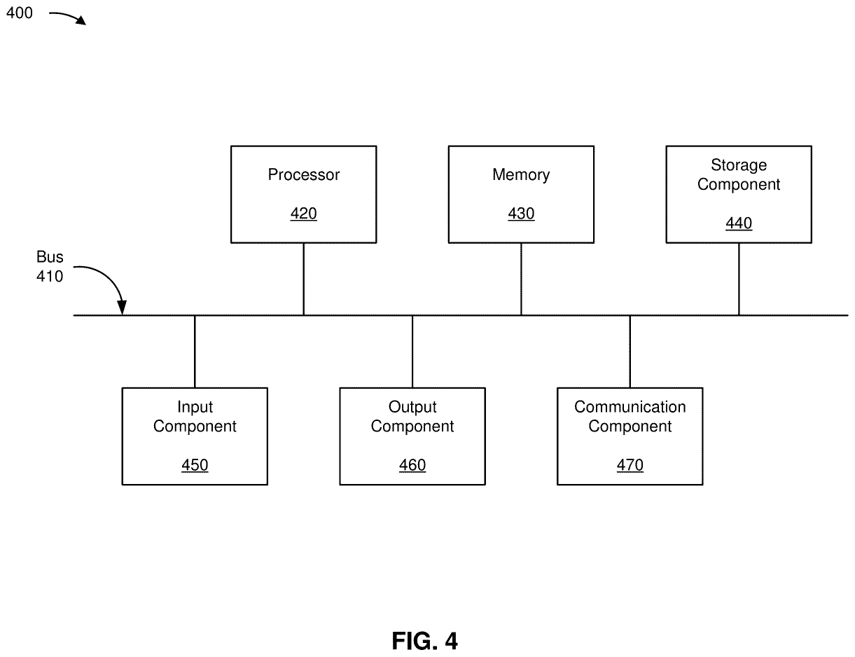

FIG. 4 is a diagram of example components of a device 400, which may correspond to the computing device 114, among other examples. In some implementations, the computing device 114 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may be a repository that stores a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

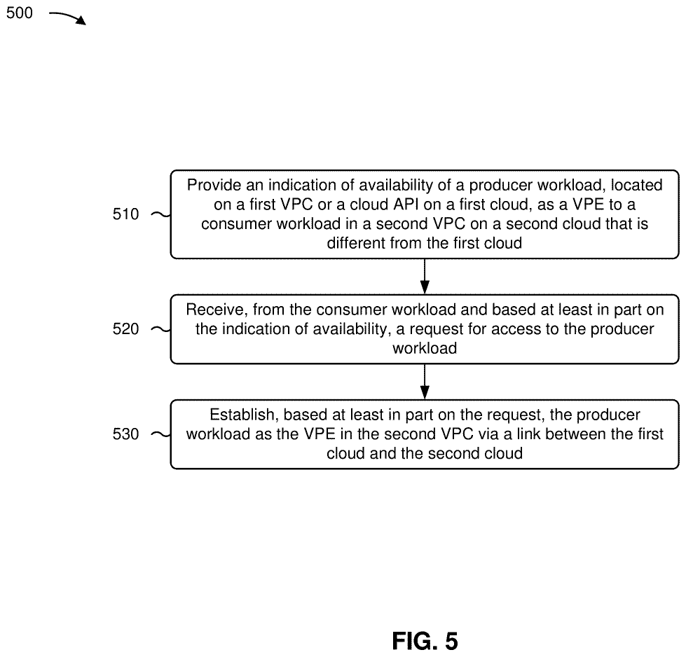

FIG. 5 is a flowchart of an example process 500 associated with cross-cloud virtual private endpoint brief description of the drawings. In some implementations, one or more process blocks of FIG. 5 may be performed by a computing device (e.g., computing device 114). In some implementations, one or more process blocks of FIG. 5 may be performed by another device or a group of devices separate from or including the computing device, such as an additional computing device, a network device, or a cloud-based device. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include providing an indication of availability of a producer workload, located on a first VPC or being a cloud API on a first cloud, as a VPE to a consumer workload in a second VPC on a second cloud that is different from the first cloud (block 510). For example, the computing device may provide an indication of availability of a producer workload, located on a first VPC on a first cloud or being a cloud API on the first cloud, as a VPE to a consumer workload in a second VPC on a second cloud that is different from the first cloud, as described above.

As further shown in FIG. 5, process 500 may include receiving, from the consumer workload and based at least in part on the indication of availability, a request for access to the producer workload (block 520). For example, the computing device may receive, from the consumer workload and based at least in part on the indication of availability, a request for access to the producer workload, as described above.

As further shown in FIG. 5, process 500 may include establishing, based at least in part on the request, the producer workload as the VPE in the second VPC via a link between the first cloud and the second cloud (block 530). For example, the computing device may establish, based at least in part on the request, the producer workload as the VPE in the second VPC via a link between the first cloud and the second cloud, as described above.

Process 500 may include additional implementations, such as any single implementation or any combination of implementations described below and/or in connection with one or more other processes described elsewhere herein.

In a first implementation, the producer workload comprises one or more of a virtual machine instance, a service, or an application hosted on the first cloud.

In a second implementation, alone or in combination with the first implementation, establishing the producer workload as the VPE in the second VPC comprises establishing a surrogate of the producer workload as the VPE in the second VPC.

In a third implementation, alone or in combination with one or more of the first and second implementations, process 500 includes receiving, before providing the indication of availability of the producer workload, an indication via the first VPC that the producer workload is available.

In some aspects, where the producer workload is a cloud API that is not associated with a VPC, the owner of the service may be the cloud provider. In some aspects, the cloud service (e.g., S3) may be published through a cross-cloud VPE management plane, a consumer surrogate may be created, and a VPE to this cloud service may be created similar to implementations where the producer workload is hosted in a VPC.

In a fourth implementation, alone or in combination with one or more of the first through third implementations, process 500 includes identifying one or more of the consumer workload or the second VPC for providing the indication of availability of the producer workload before providing the indication of availability of the producer workload.

In a fifth implementation, alone or in combination with one or more of the first through fourth implementations, establishing the producer workload as the VPE in the second VPC comprises one or more of establishing the link with a control plane and a data plane between the first cloud and the second cloud, establishing a service level objective (SLO) of the link, establishing, in the second VPC, a cross-cloud VPE associated with the producer workload, establishing a domain name system in the second VPC that resolves a consumer service name of the producer workload to a local address of the VPC, or establishing a routing configuration for the link.

In a sixth implementation, alone or in combination with one or more of the first through fifth implementations, communication between the producer workload and the consumer workload is based at least in part on the service level objective (SLO) of the link.

In a seventh implementation, alone or in combination with one or more of the first through sixth implementations, one or more of the SLO or the routing configuration is based at least in part on the producer workload, the consumer workload, or a pairing of the consumer workload and the producer workload.

In an eighth implementation, alone or in combination with one or more of the first through seventh implementations, the link between the first cloud and the second cloud comprises one or more of the internet, one or more access networks, an enterprise network, a virtual private network, a collocation device, or a tunneling network.

In a ninth implementation, alone or in combination with one or more of the first through eighth implementations, process 500 includes identifying performance of the link between the first cloud and the second cloud, and modifying link between the first cloud and the second cloud based at least in part on the performance.

In a tenth implementation, alone or in combination with one or more of the first through ninth implementations, process 500 includes identifying performance of the link between the first cloud and the second cloud, and closing the link between the first cloud and the second cloud based at least in part on the performance.

In an eleventh implementation, alone or in combination with one or more of the first through tenth implementations, process 500 includes publishing the indication of availability of the producer workload as the VPE to multiple consumer workloads on multiple VPCs.

In a twelfth implementation, alone or in combination with one or more of the first through eleventh implementations, establishing the producer workload as the VPE in the second VPC comprises establishing a link between the first VPC and the second VPC, the link including a control plane associated with parameters of the link and a data plane associated with communications between the consumer workload and the producer workload.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
providing an indication of availability of a producer workload, located on a first virtual private cloud (VPC) or being a cloud application programming interface (API) on a first cloud, as a virtual private endpoint (VPE) to a consumer workload in a second VPC on a second cloud that is different from the first cloud;
receiving, from the consumer workload and based at least in part on the indication of availability, a request for access to the producer workload; and
establishing, based at least in part on the request, the producer workload as the VPE in the second VPC via a link between the first cloud and the second cloud.

2. The method of claim 1, wherein the producer workload comprises one or more of a virtual machine instance, a service, or an application hosted on the first cloud.

3. The method of claim 1, wherein establishing the producer workload as the VPE in the second VPC comprises:
establishing a surrogate of the producer workload as the VPE in the second VPC.

4. The method of claim 1, further comprising:
receiving, before providing the indication of availability of the producer workload, an indication via the first VPC that the producer workload is available.

5. The method of claim 1, further comprising:
identifying one or more of the consumer workload or the second VPC for providing the indication of availability of the producer workload before providing the indication of availability of the producer workload.

6. The method of claim 1, wherein establishing the producer workload as the VPE in the second VPC comprises one or more of:
establishing the link with a control plane and a data plane between the first cloud and the second cloud;
establishing a service level objective (SLO) of the link;
establishing, in the second VPC, a cross-cloud VPE associated with the producer workload;
establishing a domain name system in the second VPC that resolves a consumer service name of the producer workload to a local address of the VPC; or
establishing a routing configuration for the link.

7. The method of claim 6, wherein communication between the producer workload and the consumer workload is based at least in part on the service level objective (SLO) of the link.

8. The method of claim 7, wherein one or more of the SLO or the routing configuration is based at least in part on:
the producer workload,
the consumer workload, or
a pairing of the consumer workload and the producer workload.

9. The method of claim 1, wherein the link between the first cloud and the second cloud comprises one or more of:
the internet,
one or more access networks,
an enterprise network,
a virtual private network,
a collocation device, or
a tunneling network.

10. The method of claim 1, further comprising:
identifying performance of the link between the first cloud and the second cloud; and
modifying link between the first cloud and the second cloud based at least in part on the performance.

11. The method of claim 1, further comprising:
identifying performance of the link between the first cloud and the second cloud; and
closing the link between the first cloud and the second cloud based at least in part on the performance.

12. The method of claim 1, further comprising publishing the indication of availability of the producer workload as the VPE to multiple consumer workloads on multiple VPCs.

13. The method of claim 1, wherein establishing the producer workload as the VPE in the second VPC comprises:
establishing a link between the first VPC and the second VPC, the link including a control plane associated with parameters of the link and a data plane associated with communications between the consumer workload and the producer workload.

14. A computer program product comprising:
one or more computer readable storage media, and program instructions collectively stored on the one or more computer readable storage media, the program instructions comprising:
program instructions to provide an indication of availability of a producer workload, located on a first virtual private cloud (VPC) or being a cloud application programming interface (API) on a first cloud, as a virtual private endpoint (VPE) to a consumer workload in a second VPC on a second cloud that is different from the first cloud;
program instructions to receive from the consumer workload and based at least in part on the indication of availability, a request for access to the producer workload;
program instructions to identify, based at least in part on the request, a service level objective (SLO) for a link between the producer workload and the consumer workload; and
program instructions to establish, based at least in part on the SLO, the producer workload as the VPE in the second VPC via the link between the first cloud and the second cloud.

15. The computer program product of claim 14, wherein the SLO is associated with one or more of:
a data rate of communications between the producer workload and the consumer workload,
a latency of the communications between the producer workload and the consumer workload,
a privacy configuration of the communications between the producer workload and the consumer workload, or
a cost of the communications between the producer workload and the consumer workload.

16. The computer program product of claim 14, wherein, to establish the producer workload as the VPE in the second VPC, the program instructions comprise:
program instructions establish the link with a control plane and a data plane between the first cloud and the second cloud;
program instructions to establish a service level objective (SLO) of the link;
program instructions to establish, in the second VPC, a cross-cloud VPE associated with the producer workload;
program instructions to establish a domain name system in the second VPC that resolves a consumer service name of the producer workload to a local address of the VPC; or
program instructions to establish a routing configuration for the link.

17. The computer program product of claim 14, wherein the SLO is based at least in part on one or more of:
the producer workload,
the consumer workload, or
a pairing of the consumer workload and the producer workload.

18. A system comprising:
one or more devices configured to:
provide an indication of availability of a producer workload, located on a first virtual private cloud (VPC) or being a cloud application programming interface (API) on a first cloud, as a virtual private endpoint (VPE) to a consumer workload in a second VPC on a second cloud that is different from the first cloud;
receive, from the consumer workload and based at least in part on the indication of availability, a request for access to the producer workload; and
establish, based at least in part on the request, the producer workload as the VPE in the second VPC via a link between the first cloud and the second cloud.

19. The system of claim 18, wherein the one or more devices comprise:
a virtual machine associated with the producer workload,
an application programming interface (API) server, or
a collocation facility.

20. The system of claim 18, wherein the one or more devices are configured to:
receive, before providing the indication of availability of the producer workload, an indication via the first VPC that the producer workload is available.
